(19) United States
(12) Patent Application Publication
(10) Pub. No.: US 2017/0039857 A1
(43) Pub. Date: Feb. 9, 2017

(54) SYSTEMS AND METHODS FOR INTERACTING WITH AERIAL DRONES

(71) Applicant: KENNETH S. KWAN, FOREST HILLS, NY (US)

(72) Inventor: KENNETH S. KWAN, FOREST HILLS, NY (US)

(21) Appl. No.: 15/230,306

(22) Filed: Aug. 5, 2016

Related U.S. Application Data
(60) Provisional application No. 62/202,811, filed on Aug. 8, 2015.

(51) Int. Cl. G08G 5/00; H04W 4/06; G05D 1/10; B64C 39/02; G05D 1/00; H04M 1/725; H04L 29/08

(52) U.S. Cl. CPC G08G 5/006; H04M 1/72533; H04W 4/06; H04L 67/20; B64C 39/024; G05D 1/0011; G05D 1/0061; G05D 1/101

(57) ABSTRACT

To provide third parties, such as government and private actors, control over aerial drones and/or the ability to communicate with operators of such drones, a signaling system can provide one or more instructions to drones equipped with situational control systems configured to process and/or use such instruction(s). The instruction(s) can include information presentable to the operators (e.g., via remote control mechanisms associated with the aerial drones), such as one or more options for repositioning and/or landing the drones. The instruction(s) can additionally, or alternatively, include data (e.g., coordinate or control information) usable by the aerial drones to reposition or land.

### CROSS-REFERENCE TO RELATED PROVISIONAL APPLICATION

This application claims the benefit of U.S. Provisional Patent Application No. 62/202,811, filed on Aug. 8, 2015, the disclosure of which is hereby incorporated herein by reference in its entirety.

### COPYRIGHT NOTICE

Portions of the disclosure of this patent document contain materials that are subject to copyright protection. The copyright owner has no objection to the facsimile reproduction of the patent document or patent disclosure as it appears in the U.S. Patent and Trademark Office patent files or records solely for use in connection with consideration of the prosecution of this patent application, but otherwise reserves all copyright rights whatsoever.

### FIELD OF THE INVENTION

The present invention generally relates to interactions with aerial drones.

### BACKGROUND OF THE INVENTION

Commercial aerial drones have become increasingly popular over the years. As with any new technology, however, safety, ethical, and legal issues often arise from its use. Lately, there have been incidents of people piloting their drones over private property, and property owners confronting the drones by knocking them down or damaging them. There have also been incidents of drones being flown near emergencies (such as car fires on the roadway) and interfering with emergency operations. Many of these incidents can be avoided if there is a way for third parties to communicate with the drones and/or their remote pilots, or otherwise control movement of the drone to avoid unnecessary encounters.

### SUMMARY OF THE INVENTION

Generally speaking, it is an object of the present invention to allow third parties to interact with aerial drones and/or communicate with operators of such drones.

In some embodiments, a method for effecting third-party control of an aerial drone is provided. The aerial drone can be natively controllable by an original remote control mechanism, and can have a situational control system configured to communicate with external devices. The method can include detecting, using a signaling system, the presence of the aerial drone proximate the signaling system based on communications broadcast by the situational control system, and generating, by the signaling system, at least one control signal in response to the detection. The at least one control signal can be configured to override the original remote control mechanism and at least partially control movement of the aerial drone. The method can also include transmitting the at least one control signal from the signaling system to the situational control system.

In some embodiments, an aerial drone can include a navigational system configured to control movement of the aerial drone and an associated remote control mechanism configured to communicate movement commands to the navigational system. The aerial drone can also include a situational control system configured to caused target data concerning the aerial drone to be broadcasted, receive, from a signaling system, at least one control signal configured to at least partially control movement of the aerial drone, and transmit information regarding the at least one control signal from the situational control system to the remote control mechanism. The information can include one or more selectable options to reposition or land the aerial drone. The situational control system can also receive a selection of one of the options from the remote control mechanism and cause the navigational system to control movement of the aerial drone based on the received selection.

### BRIEF DESCRIPTION OF THE DRAWINGS

For a fuller understanding of the invention, reference is made to the following description, taken in connection with the accompanying drawings, in which:

FIG. 1 is a schematic diagram of an aerial drone having a situational control system and configured to communicate with a signaling system, in accordance with various embodiments of the present invention;

FIG. 2 is an exemplary user interface of a remote control mechanism associated with an aerial drone, in accordance with various embodiments of the present invention;

FIG. 3 shows exemplary data flows between a signaling system and an aerial drone's situational control system, communication system, a remote control mechanism, and navigational system, in accordance with various embodiments of the present invention; and

FIG. 4 is a flowchart illustrating an exemplary process for effecting third-party control of an aerial drone, in accordance with various embodiments of the present invention.

### DETAILED DESCRIPTION OF THE PREFERRED EMBODIMENTS

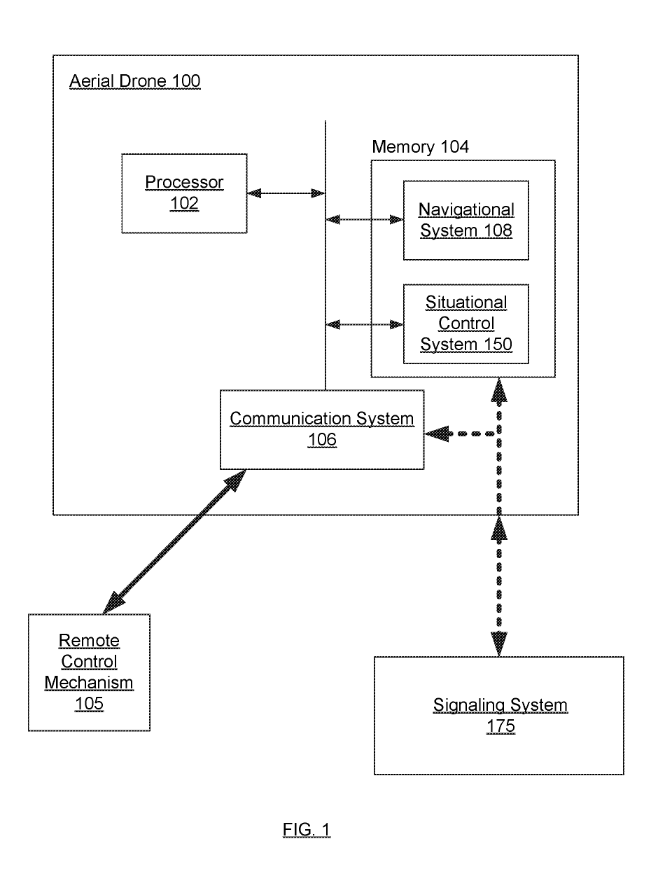

FIG. 1 is a schematic diagram of an aerial drone 100. Aerial drone 100 can represent any commercial or private aerial drone, and can include various components, such as a processor 102 (e.g., a microprocessor or other data processing device), a memory 104 (e.g., non-volatile memory, volatile memory, or both), a communication system 106, a navigational system 108, and a situational control system 150. Depending on its configuration, aerial drone 100 may include multiple processors and memories. An operating system may be run using processor 102 and may execute software applications, such as navigational system 108 and situational control system 150. Communication system 106 can be configured to communicate with external devices or systems, including, for example, a remote control mechanism 105 (which may be usable to control aerial drone 100), situational control system 150, and signaling system 175, over any suitable protocol (e.g., WiFi, radio control scheme[s], wires communication scheme[s], sound waves, ultra sound, light, infrared, or the like). Navigational system 108 can include one or more algorithms and/or applications configured to control motors/rotors of aerial drone 100 so as to maneuver the drone (e.g., in flight, to land, etc.). As general aerial drone navigational and remote control technology is well known, no further description thereof will be made herein. It is to be appreciated that embodiments of the situational control system can be used with and/or deployable to any aerial drone operating and/or application system, aerial drone navigational system, and/or remote control implementation.

Situational control system 150 can be implemented as hardware and/or software, and can be configured to interact with communication system 106 to receive and/or transmit communications from and to external devices or systems. In certain embodiments, situational control system 150 can be incorporated in or integrated with communication system 106, and can include one or more transponders, transceivers, and/or other communication mechanisms (e.g., one or more antennas, etc.). In some embodiments, situational control system 150 can include some or all of the components of a WiFi system, a traffic collision avoidance system (“TCAS” or “TCAS II”), or the like.

In preferred embodiments, situational control system 150 is implemented as one or more algorithms that receive and process communications from signaling system 175. As with situational control system 150, signaling system 175 can be implemented as hardware and/or software (e.g., in the form of one or more algorithms counterpart to algorithm(s) of situational control system 150), can include or be configured to interact with processor(s), memory, and/or communication component(s), and can be configured to receive and/or transmit communications from and to external devices or systems. In certain embodiments, signaling system 175 can be incorporated in or integrated with one or more transponders, transceivers, and/or other communication mechanisms (e.g., one or more antennas, etc.). In some embodiments, signaling system 175 can be implemented in one or more ground-based devices and/or devices onboard airborne vehicles (e.g., helicopters or the like).

In various embodiments, each of situational control system 150 and signaling system 175 can be configured to broadcast self-identifying information (hereafter referred to as target data) over a predefined frequency or frequency band using one or more predefined protocols (e.g., Wi-Fi or other radio-wave-based protocol[s]). The systems can detect each other's presence by receiving one another's broadcast data. For example, situational control system 150 can detect the presence of signaling system 175 from data being broadcast by the signaling system, and similarly, signaling system 175 can detect the presence of situational control system 150 from data being broadcast by the control system.

Embodiments of the present invention can advantageously allow government and/or private actors, for example, to seize, assume, or otherwise effect, complete or partial navigational control of a menacing aerial drone. In various embodiments, situational control system 150 can be configured to assist in the surrendering of control of navigational system 108 to signaling system 175. Situational control system 150 can, for example, be configured to detect predefined code, keys, instructions, or the like (hereafter referred to as instruction[s]) present in communications sent or broadcast by signaling system 175, and likewise, signaling system 175 can be configured to embed or include such instructions in those communications. In this sense, when an operator (e.g., user) of signaling system 175 wishes to seize control of aerial drone 100, signaling system 175 (whether automatically or via selection by the operator) can embed or include instruction(s) in one or more communications broadcast by the signaling system. Situational control system 150 can, in turn, detect the instruction(s) and determine that navigational system 108 is to be surrendered or subject to third-party control. In certain embodiments, the instruction(s) can include navigational instructions configured to redirect navigational system 108 to control aerial drone 100.

In some embodiments, signaling system 175 can identify the drone type of aerial drone 100 (e.g., from communications sent or broadcast by situational control system 150, regarding the make, model, or the like of the drone), and can retrieve appropriate instructions suitable for controlling that type of drone. Signaling system 175 can, for example, have access a repository of navigational control instructions used by various drones on the market, and can utilize these instructions to control any such drones.

In various embodiments, signaling system 175 can be configured to transmit communications to situational control system 150 when the presence of the situational control system (and thus, aerial drone 100, for example) is detected. These communications can be targeted to aerial drone 100 via identification information included in data broadcast by situational control system 150.

In certain embodiments, signaling system 175 can be configured to generate and/or transmit emergency flight routing, repositioning, and/or landing instructions to situational control system 150, and the control system can be configured to receive and process those instructions. For example, signaling system 175 can transmit communications that include one or more instructions to reposition aerial drone 100 in mid-air or to land the drone. Instructions to reposition or land can, for example, include location information (e.g., Global Positioning System [GPS] coordinates) of a nearby or distant location for repositioning or landing the drone. Locations can include, but are not limited to, directly on the ground beneath where the aerial drone is currently hovering, any location outside of a predefined radius of the aerial drone's current position, and location outside of a predefined radius of the current location of signaling system 175, and anywhere outside of a predefined radius of a particular location (e.g., a set waypoint in an aircraft's or rotorcraft's flight plan). For example, situational control system 150 can pass these received instructions (or information based thereon) to navigational system 108 to cause aerial drone 100 to conduct a landing at the specified location. This can be effected by controlling one or more motors/rotors for one or more propellers of the drone to slow down or advance such that the drone moves to the designated location.

Drones are typically controlled by one or more remote pilots or operators via remote control mechanisms (e.g., remote control mechanism 105 of FIG. 1). Many of these remote control mechanisms include (or can be modified to include) a visual display and/or an audio output mechanism for receiving images or video captured by one or more cameras coupled to the associated drones, and for outputting sound captured by one or more microphones installed on those drones. In some embodiments, situational control system 150 can be configured to pass (e.g., via communication system 106) instructions (or information based on these instructions) received from signaling system 175, to remote control mechanism 105 for presentation to the pilot or operator of aerial drone 100. The instructions can include an audible, visual (e.g., with graphics and/or text), and/or tactile alert as to the situational concern (e.g., a request by a ground-based signaling system that the drone leave the vicinity, a request by an airborne vehicle's signaling system that the drone relocate or land so as to not interfere with emergency operations, etc.).

In certain embodiments, the instruction(s) can include one or more options for repositioning or landing the drone. Each option can, for example, be presented visually, for example, and can be selectable by the operator. Upon receiving an operator selection, the remote control mechanism 105, situational control system 150, and/or communication system 106 can cause navigational system 106 (e.g., via processor 102) to reposition and/or land the drone in accordance with the selection. Remote control mechanism 105 can use any of the pre-existing drone control schemes or protocols (e.g., Wi-Fi or other frequency-based communication protocol[s]) to cause the drone to move accordingly.

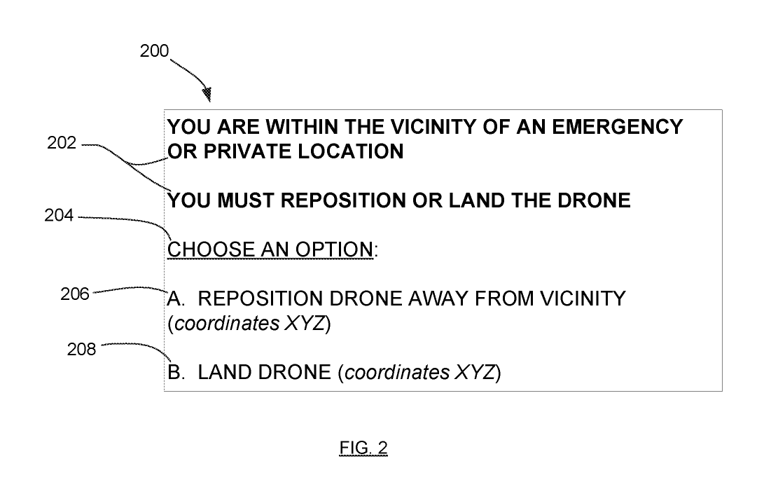

FIG. 2 is an exemplary user interface 200 of remote control mechanism 105. User interface 200 can, based on the instruction(s) from signaling system 175, present one or more of messages 202 concerning the situation of aerial drone's 100 and a prompt 204 instructing the operator of the drone to select one of options 206 and 208. If option 206 or 208 is selected (e.g., by any suitable input mechanism, such as a touch screen input or the like equipped in remote control mechanism 105), remote control mechanism 105 and/or situational control system 150 can set the appropriate reposition or landing location (whether in the form of GPS coordinates and/or control information regarding the amount and direction of motor/rotor [east, west, north, south, height, or the like]) to navigational system 108. In turn, navigational system 108 can control the drone's mechanical components to move the drone accordingly. In some embodiments, situational control system 150 can send one or more notifications to signaling system 175 indicating that aerial drone 100 is being or has been repositioned or landed.

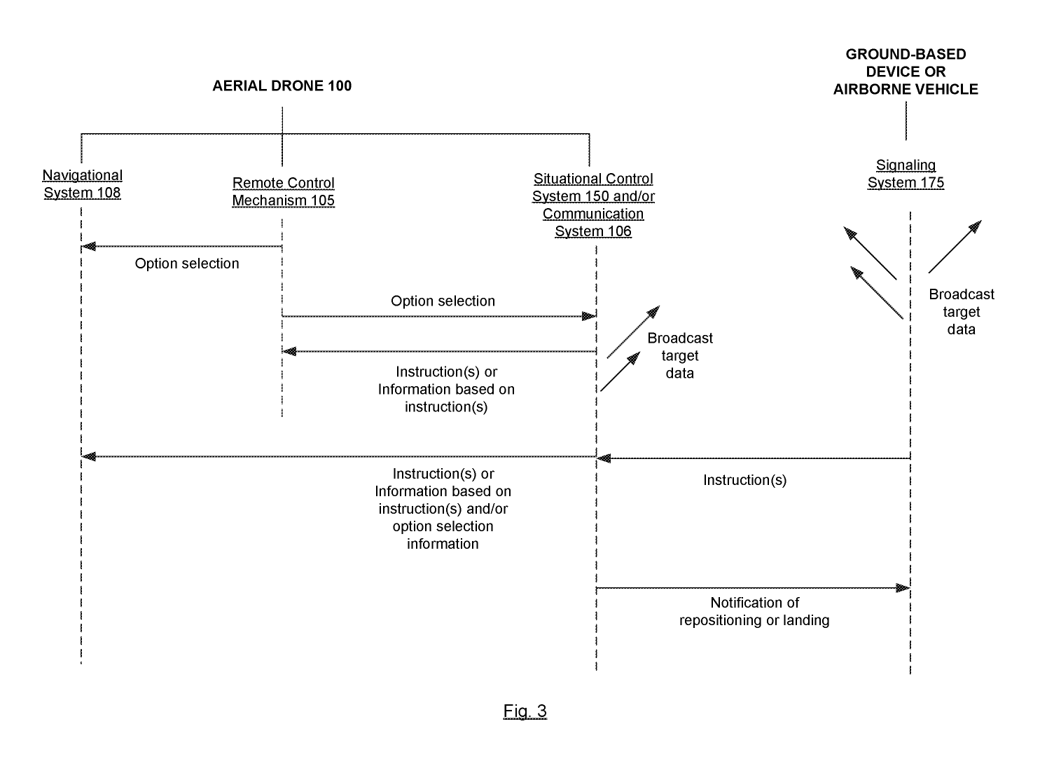

FIG. 3 shows exemplary data flows between signaling system 175, situational control system 150 and/or communication system 106, remote control mechanism 105, and navigational system 108. Each of signaling system 175 and situational control system 150 can broadcast target data including, e.g., self-identifying information. Self-identifying information can include any appropriate information, including, but not limited to, current location information of the system, Internet Protocol (IP) address, Media Access Control (MAC) address, serial number(s), part number(s), manufacturer identification information, system brand information, system model information, signal or communication detection range (e.g., in meters, feet, miles, etc.) of the system or associated communication equipment, and data broadcast range (e.g. in meters, feet, miles, etc.) of the system or associated communication equipment. Signaling system 175 can transmit one or more reposition and/or landing instructions to situational control system 150 and/or communication system 106, which can, in turn, transmit these instructions(s), or information based on these instruction(s), to remote control mechanism 105 and/or navigational system 108. In some embodiments, the instructions can include default command(s) to reposition or land the drone to or at a particular location. If these instructions are relayed directly from situational control system 150 to navigational system 108, navigational system 108 can utilize these instructions to reposition or land aerial drone 100 accordingly. In other embodiments, the instructions (or information based thereon) can be transmitted to remote control mechanism 105 for operator review and selection, as described above.

In certain embodiments, situational control system 150 can receive broadcast target data from signaling system 175, and automatically cause remote control mechanism 105 to display repositioning and/or landing options (e.g., in a manner similar to that described above). In these embodiments, situational control system 150 can utilize the location of signaling system 175 (e.g., from location information embedded or included in target data broadcast by the signaling system) to determine a suitable reposition or landing location for aerial drone 100 (e.g., directly on the ground beneath where the aerial drone is currently hovering, any location outside of a predefined radius of the aerial drone's current position, any location outside of a predefined radius of the location of signaling system 175, anywhere outside of a predefined radius of a particular location [e.g., a set waypoint in an aircraft's or rotorcraft's flight plan], or the like).

In certain embodiments, instructions transmitted by signaling system 175 can include not only relocation or landing option(s) to the aerial drone and/or its pilot, but can also be associated with one or more expiration times (e.g., 10 seconds, 30 seconds, etc.) to choose one of those options. If the drone operator fails to select one of the options or fails to relocate or land in a manner that would not interfere with the aircraft vehicle (e.g., by flying away to a location where signaling system 175 can no longer detect data being broadcast by situational control system 150, such as by using information regarding the communication or signal detection range of the signaling system), then one of the options may be automatically selected (e.g., landing the drone). The automatic selection can be made by either signaling system 175 or situational control system 150. In certain embodiments, the expiration time(s) can also be presented (e.g., visually, audibly, or the like) to the drone's operator (e.g., via remote control mechanism 105) along with a warning, to provide the operator the opportunity to reposition or land the drone on his or her own, prior to one of the repositioning or landing options being automatically selected.

In embodiments where multiple options for repositioning or landing are provided, the options can be ranked according to predefined criteria. For example, preferable options for repositioning aerial drone 100 may be shown or presented more prominently (e.g., first in a list, emboldened, etc.) than options for actually landing the drone (which may require more time and maneuvering of the drone, depending on the drone's current location and/or height from the ground).

In various embodiments, the instruction(s) from signaling system 175 can additionally cause navigational system 108 to maintain aerial drone 100 in its repositioned or landed position for a predefined period of time, irrespective of any commands from remote control mechanism 105. For example, situational control system 150 can instruct communication system 106 to ignore any incoming commands from remote control mechanism 105, or additionally or alternatively, prohibit any such incoming commands from causing navigational system 108 to maneuver aerial drone 100 from its current repositioned or landed position. In some embodiments, the prohibition can be effected immediately after one of the reposition and/or landing options is selected. This is especially advantageous in emergency situations, where an emergency aircraft, for example, wishes to land or hover at a particular location, and thus to be free from interference or distractions from aerial drones for a period of time. After the predefined period elapses, situational control system 150 can lift or remove the maneuvering restrictions, and aerial drone 100 can again be controllable by remote control mechanism 105. The predefined time can, for example, be set by an operator of signaling system 175 (e.g., at the time of issuance of the instruction(s) or preset as a default value). In certain embodiments, the instruction(s) from signaling system 175 can include an instruction that causes remote control mechanism 105 to present a notification, when the predefined time has elapsed, indicating that the operator can now resume control over aerial drone 100.

In various embodiments, when signaling system 175 seizes or effects navigational control of aerial drone 100, situational control system 150 can additionally generate and transmit an alert to remote control mechanism 105 to alert the drone's operator of the surrendered or third-party control.

In certain embodiments, situational control system 150 can additionally, or alternatively, be configured to alert or notify an operator of aerial drone 100 of nearby signaling systems, such as signaling system 175. For example, situational control system 150 can receive broadcast data output by such signaling systems, and generate and/or transmit alert(s) to remote control mechanism 105. These alerts can be presented to the aerial drone's operator to, for example, warn the operator of potential nearby emergency operations (e.g., by emergency aircraft) or nearby private property equipped with a signaling system. This can give drone operators an early opportunity to leave the area prior to their drones being potentially subjected to third-party control.

As briefly discussed above, people frequently pilot their aerial drones to areas affected by emergencies, which, whether intentional or not, can interfere with emergency operations. Oftentimes, emergency aircraft may need to land and/or hover to service the immediate area, and may be forced to wait for any interfering aerial drones in the area to disperse or relocate, causing undue delay in rescue efforts. Signaling system 175 can thus advantageously be installed on aircraft or rotorcraft. Additionally, or alternatively, signaling system 175 can be operated by one or more other entities on the ground. In various embodiments, signaling system 175 can be deployable to existing aircraft and/or rotorcraft operating and application systems, navigational systems, and the like.

In certain embodiments, signaling system 175 can be configured to receive and/or access an airborne vehicle's flight or route plan (e.g., which can be set by one or more flight operators of the airborne vehicle before the flight). In these embodiments, signaling system 175 can also receive current location information regarding the airborne vehicle, and can refrain from broadcasting target data until the vehicle is within a predefined distance from the destination in the flight plan. In this way, aerial drones that may be operating along or in the flight path of the airborne vehicle will not be subject to unnecessary warnings or alerts, and will not be subject to third-party control by signaling system 175. In other embodiments, signaling system 175 can continually, or periodically, broadcast the target data to warn or alert the aerial drones (which may be in the airborne vehicle's flight path) to reposition or move away from the airborne vehicle. In some embodiments, the signal strength of signaling system 175 can also be limited (e.g., not exceeding a certain distance, such as 100, 500 feet, 1000 feet, or 5000 feet), so as to not trigger third-party control when unwarranted.

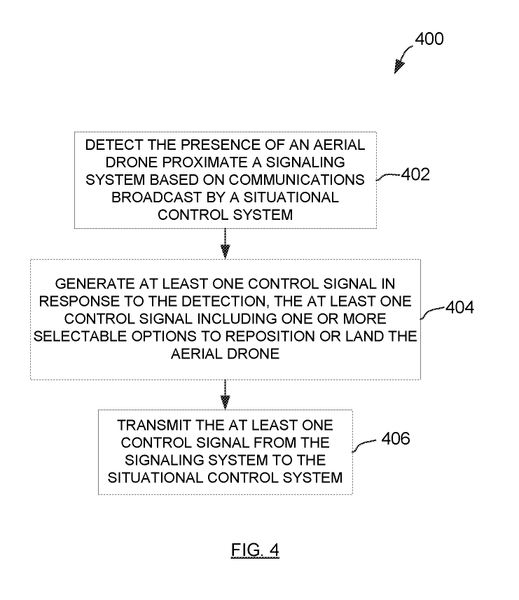

FIG. 4 is a flowchart illustrating an exemplary process for effecting third-party control of an aerial drone. The aerial drone can be natively controllable by an original remote control mechanism (e.g., remote control mechanism 105), and can have a situational control system (e.g., situational control system 150) configured to communicate with external devices or systems. At step 402, the process can include detecting, using a signaling system and at least one data processor, the presence of an aerial drone proximate the signaling system based on communications broadcast by the situational control system. For example, the process can include detecting, using signaling system 175 and at least one data processor included in or associated with the signaling system, the presence of an aerial drone proximate the signaling system based on communications broadcast by situational control system 175. As described above with respect to FIG. 1, for example, situational control system 150 can broadcast target data that includes self-identifying information. Signaling system 175 can be configured to detect this data and determine that an aerial drone, such as aerial drone 100, is nearby.

At step 404, the process can include generating, by the signaling system and the at least one data processor, at least one control signal in response to the detection. For example, the process can include generating, by signaling system 175 and the processor(s), at least one control signal in response to the detection in step 402. The at least one control signal can be configured to override the original remote control mechanism (e.g., remote control mechanism 105) and at least partially control movement of the aerial drone. In certain embodiments, the at least one control signal can include one or more instructions directed to aerial drone 100 (e.g., directed to communication system 106 and/or situational control system 150) and configured to control navigational system 108 of the drone, as described above. In certain embodiments, the at least one control signal can include one or more selectable options to reposition or land the aerial drone, as described above. In some embodiments, the control signal can be a universal control signal configured to control aerial drones manufactured by some or all manufacturers. The control signal can be created based on any appropriate standards, for example, that some or all manufacturers of aerial drones (e.g., consumer aerial drones) may follow.

At step 406, the process can include transmitting the at least one control signal from the signaling system to the situational control system. For example, the process can include transmitting the instruction(s) from signaling system 175 to situational control system 150. In various embodiments, the situational control system 150 can provide these instruction(s), or commands based on such instruction(s), to navigational system 108. Navigational system 108 can utilize these instruction(s) or command(s) to maneuver aerial drone 100, for example, to reposition or land the drone. As described above, the instruction(s) can include an instruction to land the aerial drone at a particular location, an instruction to display one or more selectable repositioning options and/or landing options to an operator of the drone, or any combination thereof.

It is to be understood that the steps shown in process 400 of FIG. 4 are merely illustrative and that existing steps may be modified or omitted, additional steps may be added, and the order of certain steps may be altered.

Moreover, the processes described herein, as well as any other aspects of the present invention, may each be implemented by software, but may also be implemented in hardware, firmware, or any combination of software, hardware, and firmware. They each may also be embodied as machine or computer-readable code recorded on a machine or computer-readable medium. The computer-readable medium may be any data storage device that can store data or instructions which can thereafter be read by a computer system. Examples of the computer-readable medium may include, but are not limited to, read-only memory, random-access memory, flash memory, CD-ROMs, DVDs, magnetic tape, and optical data storage devices (e.g., memory 104 of FIG. 1). The computer-readable medium can also be distributed over network-coupled computer systems so that the computer readable code is stored and executed in a distributed fashion. For example, the computer-readable medium may be communicated from one electronic device to another electronic device using any suitable communications protocol (e.g., the computer-readable medium may be communicated to aerial drone 100 via communication system 106). The computer-readable medium may embody computer readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that each module of each of situational control system 150 and signaling system 175 may be provided as a software construct, firmware construct, one or more hardware components, or a combination thereof. For example, these systems may each be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of each of situational control system 150 and signaling system 175 are merely illustrative, and that the number, configuration, functionality, and interconnection of existing modules may be modified or omitted, additional modules may be added, and the interconnection of certain modules may be altered.

While there have been described systems and methods for controlling output of content based on human recognition data captured by one or more sensors, it is to be understood that many changes may be made therein without departing from the spirit and scope of the invention. Those skilled in the art will appreciate that the invention can be practiced by other than the described embodiments, which are presented for purposes of illustration rather than of limitation, and the invention is limited only by the claims which follow.

What is claimed is:

1. A method for effecting third-party control of an aerial drone, the aerial drone being natively controllable by an original remote control mechanism, and having a situational control system configured to communicate with external devices, the method comprising:
detecting, using a signaling system and at least one data processor, the presence of the aerial drone proximate the signaling system based on communications broadcast by the situational control system;
generating, by the signaling system and the at least one data processor, at least one control signal in response to the detection, the at least one control signal including one or more selectable options to reposition or land the aerial drone; and
transmitting the at least one control signal from the signaling system to the situational control system.

2. The method of claim 1, wherein the at least one control signal is configured to override the original remote control mechanism by causing the aerial drone to one of reposition and land.

3. The method of claim 2, wherein the at least one control signal is configured to cause the aerial drone to reposition or land by utilizing a navigational system of the aerial drone.

4. The method of claim 2 further comprising determining whether the aerial drone is in one of a repositioned and landed position; and when the aerial drone is in the one of the repositioned and landed position, restricting further transmission of the at least one control signal.

5. The method of claim 2, wherein the at least one control signal includes information configured to restrict movement of the aerial drone after the aerial drone is one of repositioned and landed.

6. The method of claim 5, wherein the information is configured to restrict movement of the aerial drone by prohibiting control commands issued by the original remote control mechanism to control the aerial drone.

7. The method of claim 1, wherein the at least one control signal is further configured to cause the original remote control mechanism to present the one or more selectable options to reposition or land the aerial drone.

8. The method of claim 7, wherein the at least one control signal is further configured to cause the original remote control mechanism to present the one or more selectable options visually or audibly.

9. The method of claim 1, wherein the communications broadcast by the situational control system comprise at least one of manufacturer and model information regarding the aerial drone, and wherein generating the at least one control signal is effected based on a lookup operation concerning the one of the manufacturer and the model information.

10. The method of claim 1, wherein the communications broadcast by the situational control system comprise at least one of current location information of the aerial drone, an Internet Protocol (IP) address, an Media Access Control (MAC) address, serial number(s), part number(s), manufacturer identification information, brand information concerning the situational control system, model information concerning the situational control system, signal or communication detection range of the situational control system or associated communication equipment, and data broadcast range of the situational control system or associated communication equipment.

11. The method of claim 1, wherein the communications are broadcast and the at least one control signal is transmitted via any of radio waves, sound waves, ultra sound, light, and infrared.

12. The method of claim 1, wherein the at least one control signal is a universal control signal configured to control aerial drones manufactured by at least two different manufacturers.

13. The method of claim 1, wherein the signaling system is one of ground-based and aerial-based.

14. An aerial drone, comprising:
at least one data processor;
a navigational system configured to control movement of the aerial drone;
an associated remote control mechanism configured to communicate movement commands to the navigational system; and
a situational control system configured to:
cause the at least one data processor to broadcast target data concerning the aerial drone;
receive, from a signaling system, at least one control signal configured to at least partially control movement of the aerial drone;
cause the at least one data processor to transmit information regarding the at least one control signal from the situational control system to the remote control mechanism, the information including one or more selectable options to reposition or land the aerial drone;
receive a selection of one of the options from the remote control mechanism; and
cause the at least one data processor to instruct the navigational system to control movement of the aerial drone based on the received selection.

15. The aerial drone of claim 14, wherein the target data comprises at least one of current location information of the aerial drone, an Internet Protocol (IP) address, an Media Access Control (MAC) address, serial number(s), part number(s), manufacturer identification information, brand information concerning the situational control system, model information concerning the situational control system, signal or communication detection range of the situational control system or associated communication equipment, and data broadcast range of the situational control system or associated communication equipment.

16. The aerial drone of claim 14, wherein the information further comprises location data for repositioning or landing the aerial drone.
